(19) United States
(12) Patent Application Publication
(10) Pub. No.: US 2013/0113813 A1
(43) Pub. Date: May 9, 2013

(54) COMPUTING DEVICE, STORAGE MEDIUM AND METHOD FOR PROCESSING LOCATION HOLES OF MOTHERBOARD

(71) Applicants: WEN-WU WU, Shenzhen City (CN); YAN ZHUANG, Shenzhen City (CN)

(72) Inventors: WEN-WU WU, Shenzhen City (CN); YAN ZHUANG, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/452,964

(22) Filed: Apr. 23, 2012

(30) Foreign Application Priority Data
Nov. 7, 2011 (CN) 201110347931.5

(51) Int. Cl. G06T 15/00

(52) U.S. Cl. 345/522

(57) ABSTRACT

In a method for processing location holes of a motherboard, a motherboard image of the motherboard is converted into a grayscale image. The grayscale image is normalized and converted into a binary image. Closed contours in the binary image and a minimum circumscribed circle of each of the closed contours are acquired from the binary image. A radius, a circumcenter coordinate and an average pixel value of each minimum circumscribed circle, and an average pixel value of the binary image are calculated. One or more minimum circumscribed circles are selected if each of the selected minimum circumscribed circles has a radius in a predetermined radius range and an average pixel value that is greater than the average pixel value of the binary image.

### BACKGROUND

1. Technical Field

Embodiments of the present disclosure relate to systems and methods for processing motherboards of electronic devices, and more particularly, to a computing device, a storage medium, and a method for processing location holes of a motherboard.

2. Description of Related Art

A motherboard of an electronic device may include several location holes. Some holes may be configured for automated machines, such as mechanical arms, to grab the motherboard, and the other holes may be configured for fastening electronic components, such as screws. For accurately grabbing the motherboard or fastening the electronic components, it is desired a method for accurately locating the location holes of the motherboard.

### BRIEF DESCRIPTION OF THE DRAWINGS

FIG. 1 is a block diagram of one embodiment of a computing device including a location hole processing system.

FIG. 2 is a schematic diagram of one embodiment of a motherboard image.

FIG. 3 is a flowchart of one embodiment of a method for processing location holes of a motherboard using the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

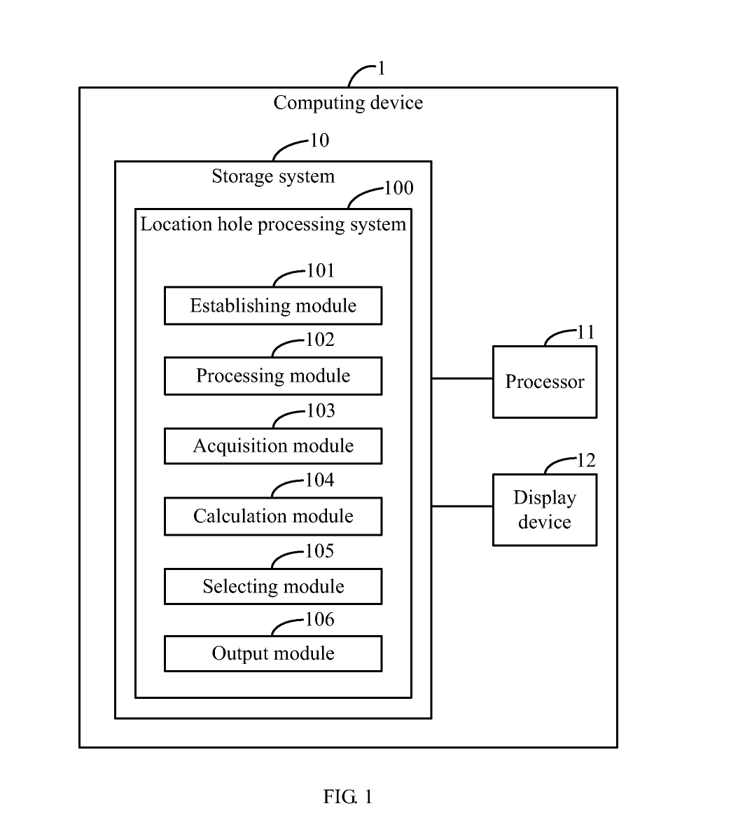

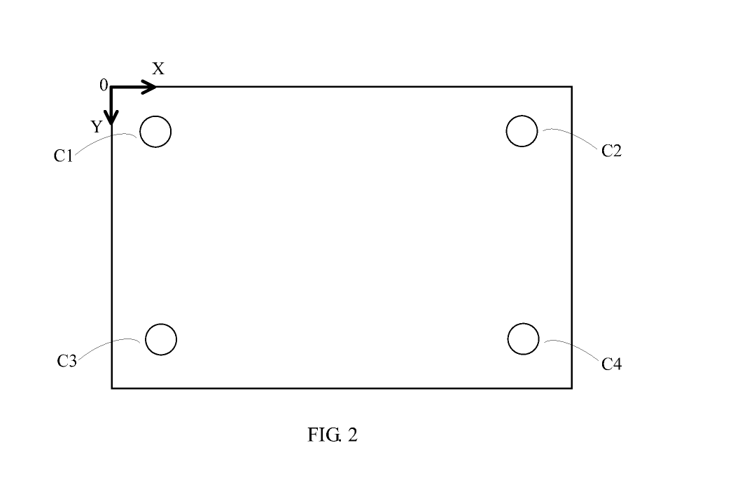

FIG. 1 is a block diagram of one embodiment of a computing device 1 including a location hole processing system 100, which is used for processing location holes of a motherboard (shown in FIG. 2). In the embodiment, the computing device 1 further includes a storage system 10, at least one processor 11, and a display device 12. The location hole processing system 100 may be in form of one or more programs stored in the storage system 10 and executed by the at least one processor 11. It is understood that FIG. 1 is just one example of the computing device 1 that can be included with more or fewer components than shown in other embodiments, or have a different configuration of the components.

The storage system 10 further stores a motherboard image. The motherboard image is defined as a digital image of the motherboard that is captured from the motherboard using an image capturing device. For example, FIG. 2 is a schematic diagram of one embodiment of the motherboard image. In addition, size data of the motherboard is recorded in the storage system 10, for example, the length of the motherboard may be one hundred centimeters, and the width of the motherboard may be eighty centimeters.

In one embodiment, the storage system 10 may be a random access memory (RAM) for temporary storage of information, and/or a read only memory (ROM) for permanent storage of information. In other embodiments, the storage system 10 may also be an external storage device, such as a hard disk, a storage card, or a data storage medium. The processor 11 executes computerized operations of the computing device 1 and other applications, to provide functions of the computing device 1.

In the embodiment, the location hole processing system 100 includes an establishing module 101, a processing module 102, an acquisition module 103, a calculation module 104, a selecting module 105, and an output module 106. The module 101-106 may comprise a plurality of functional modules each comprising one or more programs or computerized codes that can be accessed and executed by the at least one processor 11. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The establishing module 101 acquires a motherboard image from the storage system 10, and establishes a coordinate system for the motherboard image according to the size data of the motherboard that is recorded in the storage system 10. In one example with respect to FIG. 2, the establishing module 101 establishes a two-dimensional coordinate system for the motherboard image with an origin, an X-axis and a Y-axis according to the size data of the motherboard.

The processing module 102 converts the motherboard image into a grayscale image, normalizes the grayscale image, and converts the normalized grayscale image into a binary image. The grayscale image refers to an image that is composed exclusively of shades of gray, varying from black at the weakest intensity to white at the strongest intensity. Normalizing the grayscale image refers to a process that changes the range of pixel values of the grayscale image. The range of pixel values may be a range from 0 to 255. The binary image is defined as a digital image that has only two given pixel values (i.e., 0 and 255) for each pixel of the binary image. The pixel value 0 refers to white and the pixel value 255 refers to black in the binary image.

The acquisition module 103 acquires one or more closed contours from the binary image, and a minimum circumscribed circle of each of the closed contours. Each of the closed contours is defined as a polygon. The closed contours can be acquired using a contour model of the motherboard. The minimum circumscribed circle is defined as a circle that passes through all vertices of a corresponding closed contour and has a minimum area in all circumscribed circles of the corresponding closed contour. The minimum circumscribed circle of each of the closed contours can be acquired using an approximation method.

The calculation module 104 calculates a radius and a circumcenter coordinate of each minimum circumscribed circle. The radius and the circumcenter coordinate of each minimum circumscribed circle can be calculated using the approximation method.

The calculation module 104 further calculates an average pixel value of each minimum circumscribed circle, and an average pixel value of the binary image. The average pixel value of each minimum circumscribed circle is a quotient of a sum of pixel values of a corresponding minimum circumscribed circle and a number of pixels of the corresponding minimum circumscribed circle. The average pixel value of the binary image is a quotient of a sum of pixel values of the binary image and a number of pixels of the binary image.

The selecting module 105 selects one or more minimum circumscribed circles corresponding to the location holes in the binary image according to the radius and the average pixel value of each minimum circumscribed circle, and the average pixel value of the binary image.

In the embodiment, the selecting module 105 determines whether a radius of each minimum circumscribed circle is within a predetermined radius range. The predetermined radius range refers to a radius range of the location holes. For example, the predetermined radius range is from one centimeter to two centimeters. The selecting module 105 further determines whether the average pixel value of each minimum circumscribed circle is greater than the average pixel value of the binary image.

Since the location holes in the binary image may include more black pixel, the average pixel value of each of the location holes in the binary image should be greater than the average pixel value of the binary image. The selecting module 105 selects the one or more minimum circumscribed circles each of which has a radius in the predetermined radius range and an average pixel value that is greater than the average pixel value of the binary image.

The output module 106 displays the motherboard image marked with the selected minimum circumscribed circles on the display device 12 of the computing device 1, and displays the circumcenter coordinate and the radius of each selected minimum circumscribed circles on the motherboard image for observation of the user or the automated machines. Each of the selected minimum circumscribed circles indicates a location hole on the motherboard image. For example, the selected minimum circumscribed circles respectively indicate the location holes C1, C2, C3 and C4 in FIG. 2.

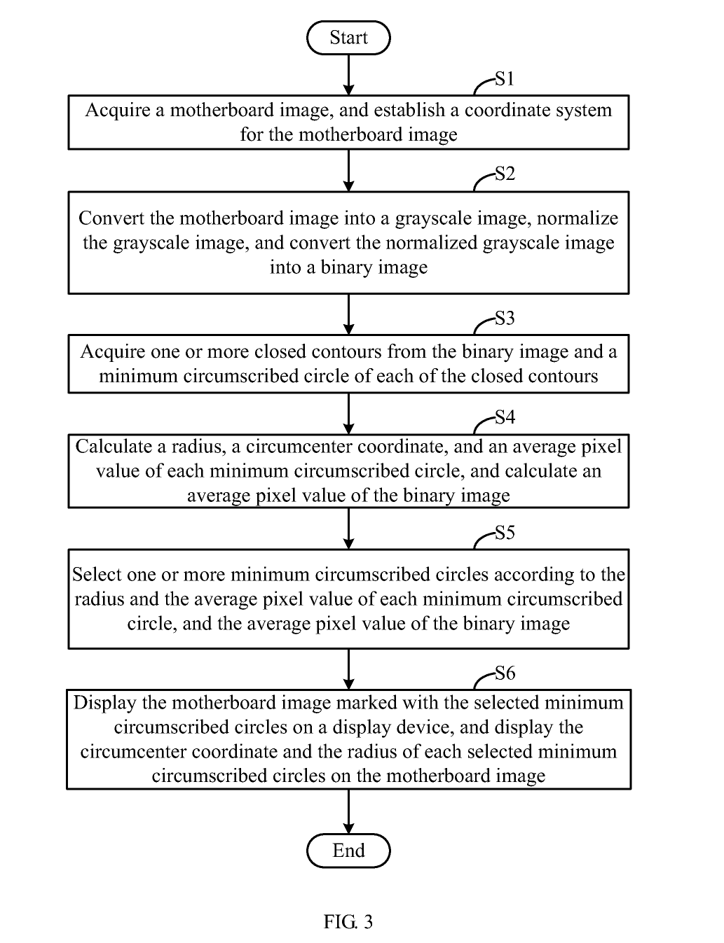

FIG. 3 is a flowchart of one embodiment of a method for processing location holes of a motherboard using the computing device 1 of FIG. 1. Depending on the embodiment, additional blocks may be added, others removed, and the ordering of the blocks may be changed.

In block S1, the establishing module 101 acquires a motherboard image from the storage system 10, and establishes a coordinate system for the motherboard image according to the size data of the motherboard that is recorded in the storage system 10.

In block S2, the processing module 102 converts the motherboard image into a grayscale image, normalizes the grayscale image, and converts the normalized grayscale image into a binary image

In block S3, the acquisition module 103 acquires one or more closed contours in the binary image, and a minimum circumscribed circle of each of the closed contours.

In block S4, the calculation module 104 calculates a radius, a circumcenter coordinate, and an average pixel value of each minimum circumscribed circle, and calculates an average pixel value of the binary image.

In block S5, the selecting module 105 selects one or more minimum circumscribed circles corresponding to the location holes in the binary image according to the radius and the average pixel value of each minimum circumscribed circle, and the average pixel value of the binary image.

In the embodiment, the selecting module 105 determines whether a radius of each minimum circumscribed circle is within a predetermined radius range, such as a radius range from one centimeter to two centimeters. The selecting module 105 further determines whether the average pixel value of each minimum circumscribed circle is greater than the average pixel value of the binary image. The selecting module 105 selects the one or more minimum circumscribed circles each of which has a radius in the predetermined radius range and an average pixel value that is greater than the average pixel value of the binary image.

In block S6, the output module 106 displays the motherboard image marked with the selected minimum circumscribed circles on the display device 12 of the computing device 1, and displays the circumcenter coordinate and the radius of each selected minimum circumscribed circles on the motherboard image for observation of the user or the automated machines. Each of the selected minimum circumscribed circles indicates a location hole on the motherboard image.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system storing a motherboard image of a motherboard;
at least one processor;
one or more programs stored in the storage system and executed by the at least one processor, the one or more programs comprising:
an establishing module that establishes a coordinate system according to the motherboard image;
a processing module that converts the motherboard image into a grayscale image, normalizes the grayscale image, and converts the normalized grayscale image into a binary image;
an acquisition module that acquires one or more closed contours from the binary image, and a minimum circumscribed circle of each of the closed contours;
a calculation module that calculates a radius, a circumcenter coordinate, and an average pixel value of each minimum circumscribed circle, and calculates an average pixel value of the binary image;
a selecting module that selects one or more minimum circumscribed circles each of having a radius in a predetermined radius range and an average pixel value that is greater than the average pixel value of the binary image;
an output module that displays the motherboard image marked with the selected minimum circumscribed circles on a display device of the computing device, and displays the circumcenter coordinate and the radius of each selected minimum circumscribed circles on the motherboard image.

2. The computing device of claim 1, wherein the storage system further records size data of the motherboard that includes a length value and a width value of the motherboard.

3. The computing device of claim 2, wherein the establishing module establishes the coordinate system according to the size data of the motherboard.

4. The computing device of claim 1, wherein the closed contours are acquired using a contour model of the motherboard.

5. The computing device of claim 1, wherein the minimum circumscribed circle of each of the closed contours is acquired using an approximation method.

6. A method for processing location holes of a motherboard using a computing device, the method comprising:
(a) establishing a coordinate system according to a motherboard image of the motherboard;
(b) converting the motherboard image into a grayscale image, normalizing the grayscale image, and converting the normalized grayscale image into a binary image;
(c) acquiring one or more closed contours from the binary image, and a minimum circumscribed circle of each of the closed contours;
(d) calculating a radius, a circumcenter coordinate, and an average pixel value of each minimum circumscribed circle, and calculating an average pixel value of the binary image;
(e) selecting one or more minimum circumscribed circles each of having a radius in a predetermined radius range and an average pixel value that is greater than the average pixel value of the binary image;
(f) displaying the motherboard image marked with the selected minimum circumscribed circles on a display device of the computing device, and displaying the circumcenter coordinate and the radius of each selected minimum circumscribed circles on the motherboard image.

7. The method of claim 6, wherein the storage system further records size data of the motherboard that includes a length value and a width value of the motherboard.

8. The method of claim 7, wherein the block (a) further comprises:
establishing the coordinate system according to the size data of the motherboard.

9. The method of claim 6, wherein the closed contours are acquired using a contour model of the motherboard.

10. The method of claim 6, wherein the minimum circumscribed circle of each of the closed contours is acquired using an approximation method.

11. A non-transitory storage medium storing a set of instructions, the set of instructions capable of being executed by a processor of a computing device, causes the computing device to execute a method for processing location holes of a motherboard, the method comprising:
(a) establishing a coordinate system according to a motherboard image of the motherboard;
(b) converting the motherboard image into a grayscale image, normalizing the grayscale image, and converting the normalized grayscale image into a binary image;
(c) acquiring one or more closed contours from the binary image, and a minimum circumscribed circle of each of the closed contours;
(d) calculating a radius, a circumcenter coordinate, and an average pixel value of each minimum circumscribed circle, and calculating an average pixel value of the binary image;
(e) selecting one or more minimum circumscribed circles each of having a radius in a predetermined radius range and an average pixel value that is greater than the average pixel value of the binary image;
(f) displaying the motherboard image marked with the selected minimum circumscribed circles on a display device of the computing device, and displaying the circumcenter coordinate and the radius of each selected minimum circumscribed circles on the motherboard image.

12. The storage medium of claim 11, wherein the storage system further records size data of the motherboard that includes a length value and a width value of the motherboard.

13. The storage medium of claim 12, wherein the block (a) further comprises:
establishing the coordinate system according to the size data of the motherboard.

14. The storage medium of claim 11, wherein the closed contours are acquired using a contour model of the motherboard.

15. The storage medium of claim 11, wherein the minimum circumscribed circle of each of the closed contours is acquired using an approximation method.
